(19) United States
(12) Patent Application Publication
(10) Pub. No.: US 2021/0374668 A1
(43) Pub. Date: Dec. 2, 2021

(54) GOODS DELIVERY CONTRACT SYSTEM

(71) Applicant: Kazuto Nakamura, Osaka (JP)

(72) Inventor: Kazuto Nakamura, Osaka (JP)

(21) Appl. No.: 17/221,467

(22) Filed: Apr. 2, 2021

(30) Foreign Application Priority Data
May 27, 2020 (JP) 2020-092410

(51) Int. Cl. G06Q 10/08; G06Q 30/02; G06Q 50/30

(52) U.S. Cl. CPC G06Q 10/08345; G06Q 50/30; G06Q 10/0833; G06Q 30/0284

(57) ABSTRACT

A goods delivery contract system properly calculates the delivery fee for delivering goods from a vendor to a customer, comprising a management server, a vendor terminal for vendors that supply goods, a customer terminal that make goods order and delivery requests to the management server, and a deliveryman terminal that deliver goods. The management server comprises a notice means to notify the vendor terminal and the plural deliveryman terminal of the goods delivery business information received from the customer terminal all at once, and a calculation means to calculate the delivery fee for each deliveryman. The deliveryman terminal sends the business end place information in the reply information. The calculation means calculates the required moving time between the starting place of the delivery business, the supply place of goods, the delivery place of goods, and the end place of business, and calculates the delivery fee from the calculated time.

This application claims the benefit of priority to Japanese Patent Application No. 2020-092410, filed May 27, 2020, which is incorporated herein by reference in its entirety.

### FIELDS OF THE INVENTION

The present invention relates to a goods delivery contract system in which an individual deliveryman contracts a goods delivery business in free time.

### BACKGROUND OF THE INVENTION

In recent years, based on a communication network that uses terminal devices such as smartphones and the Internet, many service provision systems have been built on that platform, and various forms of economic activities are being carried out using such systems.

Among these economic activities are the sharing economy and gig economy, which are closely related to concepts such as side business and freelance business.

The gig economy “gig” is said to be derived from the terminology of the music industry.

In the sharing economy, there is a form in which personal assets (for example, private cars and vacant rooms) are used by others for a fee during the time or period when they are not used, which is called the sharing economy. It can be called the sharing economy.

The gig economy is an economic activity in which an individual freely uses his/her free time to work on a one-off basis and earn income, which can also be called an empty lending economy. In addition, personal assets can include individual labor force other than things such as cars and houses. It can be said that the gig economy provides an individual labor force, which is a vacant self-asset, as a service (also called labor) for obtaining compensation.

As an example of the gig economy, there is known a food delivery system in which a gig worker who receives a request from an operator delivers food using a bicycle or a motorcycle (for example, Non-Patent Document 1).
[Non-Patent Document 1] “Wikipedia”, [online], [Searched on Apr. 8, 2020], Internet (URL: https://en.wikipedia.org/wiki/Uber_Eats)

In the food delivery system as shown in Non-Patent Document 1 described above, the deliveryman who is a gig worker who provides labor in the gig economy can work on a one-off basis by freely using free time, but says that the treatment for the deliveryman is not good.

According to the description of Non-Patent Document 1, this food delivery system is not a uniform delivery fee but a delivery fee that fluctuates according to the distance, and the deliveryman can receive a reward depends on the number of deliveries and the distance between the restaurant and the delivery destination.

However, it cannot be said that the minimum hourly wage can be guaranteed for the deliveryman. Also, it is difficult to estimate the price of labor so that it is appropriate for both the gig worker and the operator. A system that can properly evaluate the labor compensation of individual gig workers is desired.

An object of the present invention is to solves the above-mentioned problems, and to provide a good delivery contract system that can appropriately calculates a delivery fee, which is a consideration for a deliveryman who receives goods from a vendor and deliver them to a customer.

### SUMMARY OF THE INVENTION

In order to solve the above problems, the goods delivery contract system of the present invention, comprising:

a management server managed by an operator who operates the goods delivery contract system;

a customer terminal used by a customer who joins the system requests the management server to order and deliver goods;

a vendor terminal used by a vendor who joins the system and supplies the goods;

a deliveryman terminal carried by a deliveryman who joins to the system for contract a delivery business that receives the goods at a supply place and delivers them to the customer;

the management server comprising,

a request receiving means that receives goods order delivery requests from the customer terminal specified a delivery place,

an order notice means that notifies the vendor terminal of information about goods order delivery received by the request receiving means, and notifies a plural deliveryman terminal all at once of information about goods order delivery received by the request receiving means, wherein a place where each of plural deliveryman always locate is registered as the starting place of delivery business, and

a calculation means for calculating a delivery fee for each deliveryman based on a reply information requesting delivery sent from the deliveryman terminal;

the deliveryman terminal has a deliveryman response means for sending information including a delivery business end place designated by the deliveryman in the reply information to the management server in response to a notice from the order notice means;

wherein in the goods delivery contract system;

the calculation means of the management server is configured;

to calculate a total moving distance based on a first distance from the delivery starting place which is registered on the management server to a goods supply place by the vendor, a second distance from the goods supply place to the delivery place, and a third distance from the delivery place to the delivery business end place,

to calculate a required moving time based on the total moving distance and a running speed of a transportation used by the deliveryman, and

to calculate a delivery fee for each deliveryman based on the moving time and minimum hourly wage in an area where the delivery business takes place.

In the goods delivery contract system, the management server has a position detecting means that detects position of the deliveryman terminal,

the position detecting means is configured;

to judge whether or not the position of the deliveryman terminal detected by the position detecting means is farther than the specified distance from a registered place where the deliveryman always locates, and

to exclude the deliveryman terminal from the calculation if it is determined that they are far apart.

In the goods delivery contract system, the management server has a position detecting means that detects the deliveryman terminal position,

the order notice means is configured;

to detect whether or not the position of the deliveryman terminal detected by the position detecting means is in a moving towards the delivery end place after delivery by the deliveryman,

if it is detected that the deliveryman terminal is in the moving towards the delivery end place, and newly delivery business occurs,

to detect whether or not a position of the deliveryman terminal is within a predetermined distance from a goods supply place of the newly delivery business, and

to preferentially push notice about the new delivery business to the deliveryman terminal when detected position is within the specified distance.

In the goods delivery contract system, the management server has a selection means that selects a deliveryman based on the delivery fee for each deliveryman calculated by the calculation means;

the calculation means is configured to calculate the total cost of the delivery business by the deliveryman and ordered goods;

the order notice means is configured;

to notify the customer terminal of the total charge and scheduled delivery time for the deliveryman selected by the selection means, and

to notify the vendor terminal and the selected deliveryman terminal respectively of the decision to order goods and the decision to request delivery, when a consent notice from the customer terminal is received.

In the goods delivery undertake system, the supplier gets the app that runs on the supplier terminal from the management server when the supplier joins to the system,

the customer obtains a customer app that runs on the customer terminal from the management server when the customer joins to the system, and

the deliveryman obtains a deliveryman app that runs on the deliveryman terminal from the management server when the deliveryman joins to the system.

According to the goods delivery contract system of the present invention, the delivery fee is based on the moving route from the start place of the delivery registered in advance by the deliveryman to the end place of the delivery specified when requesting the contract business. Therefore, it is possible to calculate an appropriate delivery fee for the operator and the deliveryman.

### BRIEF DESCRIPTION OF THE DRAWINGS

FIG. 1 is a configuration diagram of goods delivery contract system according to an embodiment of the present invention.

FIG. 2 is a diagram showing a delivery route which a deliveryman moves.

FIG. 3 is a diagram showing a transition of a customer terminal screen when a customer selects goods using the customer terminal.

FIG. 4 is a diagram showing a transition of the customer terminal screen when a customer requests an order and delivery for goods using the customer terminal.

FIG. 5 is a diagram showing the transition of each screen of a vendor terminal and a deliveryman terminal for goods supply and delivery after ordering the goods by the customer terminal.

FIG. 6 is a sequence diagram showing an operation of the system.

FIG. 7 is a configuration diagram of a management server in an application example of the system.

FIG. 8 is a diagram showing a delivery route which a deliveryman moves according to the application example.

### DETAILED DESCRIPTION OF THE INVENTION

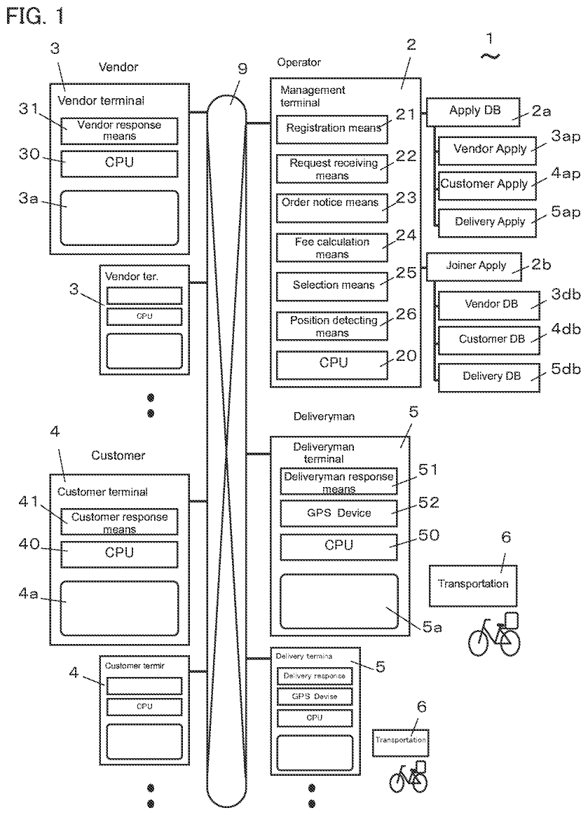

Hereinafter, a goods delivery contract system according to an embodiment of the present invention will be described with reference to the drawings. As shown in FIG. 1, the goods delivery contract system 1 (hereinafter referred to as system 1) comprising; a management server 2 managed by an operator that operates the system 1, a vendor terminal 3, a customer terminal 4, and a deliveryman terminal 5 that are used and operated by each of a plurality of vendors, customers, and deliverymen that are members of system 1. Each of the terminals 3, 4 and 5 can communicate with the management server 2 via network 9. The network 9 is a communication network using the Internet, but is not limited to such a communication network.

Vendor supplies deliverable goods to a customer. For example, when goods are food, they are a bakery owner, a fast-food owner, and various cafeteria owners such as Japanese style and Chinese food. Each vendor registers the goods catalog in the management server 2 of the system 1. Order of goods from customer to the vendor is done via the management server 2. Customer uses a customer terminal 4 for requesting the goods order delivery from the management server 2.

Deliveryman is notified from the system 1 to the deliveryman terminal 15 that it has been selected as the deliveryman for the delivered goods ordered, and then receives the goods from the supply place of the goods by the vendor and contracts the delivery business to deliver to the customer. Embodiment describes the case where goods are food products such as hamburgers, but the system 1 is not limited to food products, and any goods are targeted for delivery.

### (Management Server)

The management server 2 provides a registration means 21, a request receiving means 22, an order notice means 23, a calculation means 24, a selection means 25, a position detecting means 26, a processor 20, an application database 2a, and a joiner database 2b. The management server 2 is a computer equipped with hardware such as a normal input/output device and memory as a server, basic software (called OS) that operates the management server 2, and software such as an application program that operates on the OS.

The registration means 21, the request receiving means 22, the order notice means 23, the calculation means 24, the selection means 25, and the position detecting means 26 are composed of the application program on the OS. The processor 20 is composed of a microprocessor and the like, which are semiconductor elements that operate the software and operate the management server 2.

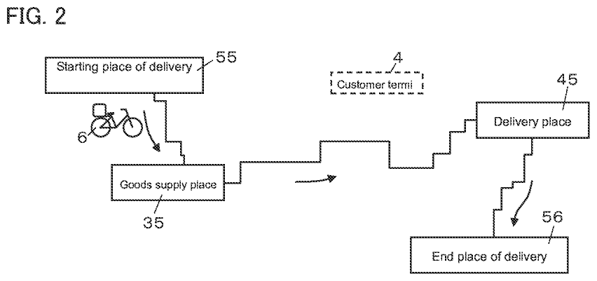

The registration means 21 is used by vendor, customer, and deliveryman to register and record the identification information and necessary registration items of these joiners on the joiner database 2b when joining to system 1. The registration means 21, for example, records the position information of the always-located place specified and pre-registered by the deliveryman as a delivery starting place (55) (FIG. 2) of the delivery business in the deliveryman database 5db when the deliveryman joins the system 1.

The request receiving means 22 receives a goods order and a delivery request made by specifying delivery place (45) (FIG. 2) from customer terminal 3.

The order notice means 23 notifies the vendor terminal 13 and one or plural deliveryman terminal 15 of the information about the goods order delivery received by the request receiving means 22.

The calculation means 24 calculates the delivery fee for each deliveryman based on the reply information that the deliveryman wants to contract the delivery which is sent from the deliveryman terminal 15.

The selection means 25 selects one deliveryman based on the delivery fee for each deliveryman calculated by the calculation means 24.

The position detecting means 26 acquires the information indicating the position of the deliveryman terminal 15 sent from the deliveryman terminal 15 and detects the position of the deliveryman. The position detecting means 26 is used to confirm the location of a deliveryman, for example, when to notify a deliveryman within a limited position or when the deliveryman is in the process of delivery.

The application database 2a stores an application program (hereinafter referred to as “app”) that is downloaded from the management server 2 and used by the external terminal. This application includes a vendor application 3ap, a customer application 4ap, and a deliveryman application 5ap, which respectively operate on the vendor terminal 3, the customer terminal 4, and the deliveryman terminal 5. Each terminal 3, 4, 5 receives a notification from the management server 2 using these applications and responds to the management server 2. These applications are downloaded and installed in each terminal 3, 4 and 5 by the vendor, customer and deliveryman joining the system 1.

The joiner database 2b is equipped with a vendor database 3db, a customer database 4db, and a deliveryman database 5db that record the registration information submitted to the system 1 when each of the vendor, customer, and deliveryman joins the system 1. Registration information is the identification information of each joiner (account, which consists of a unique string that can be identified for each joiner and a secret password), and information to be register required from the system 1 to each joiner.

### (Vendor Terminal)

The vendor terminal 3 is a terminal used by the vendor to join the system 1 and process the ordering and supply of goods via the management server 2. The vendor terminal 3 may be a computer that has a communication function that can be connected to the network 9 and an input/output response function with vendor, and may be a smartphone.

The vendor terminal 3 is equipped with a vendor response means 31 that sends an acceptance response to the management server 2 in response to a notice of order from the management server 2, a processor 30, and a display screen 3a for input/output. The processor 30 operates the software to operate the vendor terminal 3. The display screen 3a is, for example, a user interface that has an input/output function by display and screen touch. The vendor operates the vendor response means 31 by operating the display screen 3a, and exchanges information with the management server 2 about the delivery time and place which are goods supply condition for example.

### (Customer Terminal)

The customer terminal 14 is a terminal used by customers to join system 1 and process goods ordering and payment via the management server 2. The customer terminal 4 may be a computer having a communication function that can be connected to the network 9 and an input/output response function with the customer, and may be a smartphone.

The customer terminal 4 is equipped with a customer response means 41 that sends an order notice to the management server 2 and receives a notice from the management server 2, a processor 40, and a display screen 4a for input and output. The processor 40 operates the software to operate the customer terminal 4. The display screen 4a is, for example, a user interface that has an input/output function by display and screen touch. By operating the display screen 4a, the customer operates the customer response means 41 to process goods orders, delivery requests, payments, etc. to the management server 2.

### (Deliveryman Terminal)

The deliveryman terminal 5 is used to exchange information with the management server 2 for executing contract of the goods delivery when the deliveryman joins the system 1. The deliveryman terminal 5 is a terminal with a communication function carried by a deliveryman who moves with goods, and is a portable computer having a communication function that can be connected to a network 9 and an input/output response function with the deliveryman. For example, a smart phone is preferably used.

The deliveryman terminal 5 has a deliveryman response means 51, a GPS device 52, a processor 50, and a display screen 5a for input and output. The processor 50 operates the software to operate the deliveryman terminal 5. The display screen 5a is, for example, a user interface that has an input/output function with display and screen touch.

The deliveryman response means 51 sends the information of the delivery end place (56) (FIG. 2), which the deliveryman schedules and specifies, and the transportation 6 used for the delivery, to the management server 2 when the deliveryman responds to contract the delivery.

The GPS device 52 is a device that acquires information on the current position of the deliveryman terminal 5 that moves with the deliveryman. Position information obtained by this GPS device 52 is displayed on a map displayed on the display screen 5a for example during the delivery business by the deliveryman, and can be used to figure out the positional relationship between the delivery place 45 (FIG. 2) of goods and the current location. In addition, the position information is periodically sent from the deliveryman terminal 5 to the management server 2, so that the management server 2 can grasp the position of the deliveryman terminal 5.

### (Goods Delivery and Delivery Fee)

As shown in FIG. 2, the delivery man starts moving using transportation 6 from the starting place 55 of the delivery business. The deliveryman moves to the goods supply place 35, receives the goods there, moves to the goods delivery place 45, completes the delivery of the goods there, then moves to the delivery business end place 56, where the delivery business ends. The transportation 6 includes walking.

The starting place (55) of the delivery business is the position information specified when the deliveryman joins the system 1, and is registered on the management server 2. The starting place 55 is a place where the deliveryman can receive the request of the delivery business from the system 1, and is a place where the deliveryman always locate when undertaking the delivery business. This always locate place can be a place where a deliveryman whose side business is a delivery business (for example, a gig work) takes a break or a place such as a home or a company engaged in the main business. Thus, a place where each of plural deliveryman always locate is registered as the starting place of delivery business.

The supply place (35) of goods is a place designated in advance by the vendor. For example, in the case of a large restaurant operated by the vendor, there is a dedicated goods take-out window or a goods delivery window for delivery.

The delivery place (45) of goods is a place specified by the customer when ordering goods to the management server 2. The delivery place (45) of goods is not always a location of customer or the customer terminal 4. In addition, the recipient of goods may be different from the customer, and may be a receiving locker that does not face the recipient.

The end place (56) of the delivery business is a place specified by the deliveryman when the deliveryman expresses his desire to contract the delivery business by receiving the notice of information about the delivery business from the order notice means 23. The position information of the end place (56) is notified to the management server 2 by the deliveryman response means 51. The delivery business end place (56) can be arbitrarily specified by the delivery man. For example, if the starting place (55) of the delivery business, which is the place where he is always located, is not his home or office, he can specify the deliveryman's home or office or any place on his way to his home or office, as the end place (56).

Delivery fee is calculated by the calculation means 24. The calculation means 24 usually calculates a delivery fee for each deliveryman based on each of the reply information that they want to contract the delivery business sent from multiple deliveryman terminals 5. The delivery fee is the basic information for judging to select one delivery man.

The calculation means 24 first calculates a moving distance between each following place; the starting place (55) of the delivery pre-registered by the delivery man, the supply place (35) of the goods by the vendor, the delivery place (45) specified by the customer, and the delivery end place (56) specified by including in the reply information. The calculation of the moving distance is performed based on, for example, the route search that follows the road in the digital road map information. Next, the calculation means 24 calculates the required moving time based on the calculated moving distance and the moving speed determined according to the information of the transportation 6 specified in reply information. Furthermore, the calculation means 24 calculates the delivery fee for each delivery man from the moving time and the minimum hourly wage of the area where the delivery business is performed.

The above moving distance is a total moving distance that is the sum of the following distances;

(A) The first distance from the starting place (55) to the goods supply place (35),
(B) The second distance from the supply place (55) to the delivery place (45), and
(C) The third distance from the delivery place (45) to the end place (56) of delivery business.

The moving speed is determined in accordance with the transportation 6, for example, 18 km/h (1.5 km/5 minutes) for a bicycle and 30 km/h (2.5 km/5 minutes) for an auto bike. Using these, the moving time required for moving the total moving distance is calculated. The time required for the delivery business is calculated by adding the miscellaneous time such as the waiting time for giving and receiving goods to the moving time. For this labor time, the delivery fee to be paid to the delivery man is determined so that it does not fall below the minimum hourly wage in each region. The calculation means 24 calculates the delivery fee for each deliveryman who responds to contract the delivery business.

### (Calculation Example)

Provided that the deliveryman departs from the place where the deliveryman always locates (the starting place 55 of the delivery business) and moves to the following distance in order, the total moving distance will be 3 km.

(i) distance from the starting place 55 to vendor store (goods supply place 35): 0.5 km,
(ii) distance from the supply place 35 to delivery place (goods delivery place 45): 1.5 km,
(iii) distance from the delivery place 45 to business completion location (delivery business end place 56): 1 km.

If the time required for running is 10 minutes when traveling by motorcycle and the miscellaneous time such as waiting time is 10 minutes, a total of 20 minutes will be the labor time required for the delivery business. Assuming that the minimum hourly wage per hour (60 minutes) in the area where system 1 is applied is 12 USS, the consideration for the delivery business is 4 US$, and is 4.4 US$ (I) including sales tax 10%. This amount is calculated as a delivery fee. The delivery fee may include the fee paid to system 1.

Assuming that the goods price is 11 US$ (II) including sales tax, the total amount of (I)+(II) is 15.4 US$. In the case of card payment, 0.308 US$ will be added due to the card settlement fee of 2%. The card payment amount (final total fee) by the customer will be 15.708 US$. The goods price (II) is the amount including the fee paid to the system 1. The commission ratio is set arbitrarily in consideration of market trends. A fixed amount of basic fee may be set for each delivery business, and if the moving distance or time for delivery is short, at least this basic fee may be paid to the delivery man.

A difference of the transportation 6 is taken into account in the calculation of the delivery fee. For example, if an auto bike is used as the transportation 6, the cost of the auto bike may be added. The delivery fee may be included fees in consideration of the degree of road congestion that changes depending on the date and time, in addition to miscellaneous times such as waiting time for pick-up and delivery at supply place 55 and delivery place 45. The transportation 6 is not limited to a single delivery business, and plural transportation may be used in combination. For example, in a place where light vehicles cannot enter, walking is used as transportation.

The selection means 25 compares the delivery fees calculated for each deliveryman, and selects, for example, one deliveryman with the smallest delivery fee. The selected delivery man will start the delivery business after a negotiation have been concluded on the goods transaction with the customer.

### (Goods Selection and Ordering)

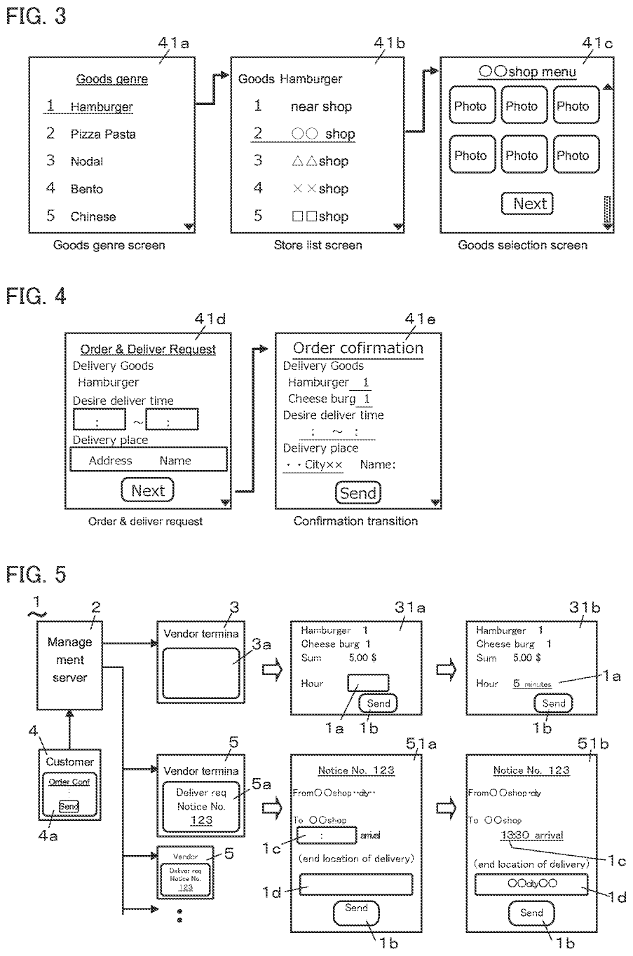

Next, an example of selecting and ordering goods performed by a customer using the customer terminal 4 will be described. As shown in FIG. 3, the customer who joined the system 1 browses the goods catalog registered in the system 1 using the customer terminal 4, selects goods, and places an order. For example, when ordering food for delivery, the customer logs in to the specified home page on the management server 2 using the customer terminal 4, and opens and displays goods genre screen 41a for food.

On the goods genre screen 41a, the genre name of the food is displayed in a selectable manner. If the customer selects the genre of the first hamburger for example, the store list screen 41b focused the vendor that supplies the hamburger as goods is displayed. Next, for example, if the second XX store is selected, the goods selection screen 41c showing the hamburgers supplied by the XX store and their related foods with pictures will be displayed. After selecting and deciding the desired goods on this screen, the customer taps the next button to move to the next screen.

As shown in FIG. 4, the order and deliver request screen 41d is displayed on the customer terminal 4. On this screen, enter and specify the desired delivery time and the specified delivery place. When the customer taps the next button, the confirmation transmission screen 41e for confirming the order details and the specified details will be displayed. When the customer confirms the description and taps the send button, information about the goods order delivery request is sent from the customer terminal 4 to the management server 2. These processes are performed based on the functions of the customer application 4ap.

Next, description is an example of the processing performed for the supply and delivery of goods after the order for goods and the delivery request are made from the customer terminal 4. As shown in FIG. 5, when the customer terminal 4 sends information about goods orders and delivery requests to the management server 2, those information are edited into the required information, respectively, and will be notified to the vendor terminal 3 and the deliveryman terminal 5.

The order information is notified to the vendor terminal 3 of the vendor that operates the XX store specified by the customer. The delivery request information is notified to the deliveryman terminal 5 of one or plural deliveryman who is registering the starting place 55 of the delivery business within the predetermined distance from the XX store specified by the customer.

The notice reply screen 31a is displayed on the vendor terminal 3 of which the order notice has been made. This screen shows the form for entering the goods name, quantity, total amount of goods, and a creation time 1a required to create goods. For example, the vendor fills in the creation time of 5 minutes, taps the reply button on the screen 31b after filling in, and responds to the management server 2.

A notice reply screen 51a is displayed on the deliveryman terminal 5 of which the notice of the delivery request has been made. This screen shows a form for entering the content of the request to deliver goods from where to where and for entering the following two items. One entry is the arrival time (lc), which is the time when the deliveryman can arrive at the goods supply place XX store. The other is position 1d, which is the end place 56 of the delivery business.

For example, the deliveryman fills in the arrival time (1c) at 13:30 and the position 1d of the end place indicated by the lot number, taps the reply button on the screen 51b after filling in, and responds to the management server 2.

### (Processing in System)

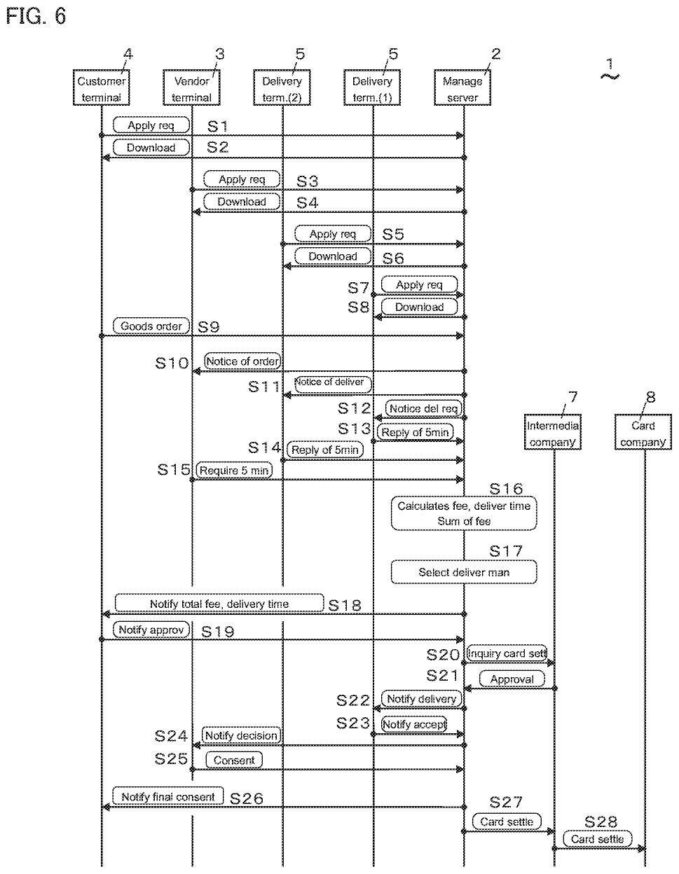

Next, a series of processing flows in the system 1 will be explained using a sequence diagram. As shown in FIG. 6, for a brief explanation, there are two deliveryman terminals 5 (1)(2) for which delivery requests are notified, one customer terminal 4 on the ordering side, and one vendor terminal 3 on the side to be ordered. The two deliveryman terminals 5 (1)(2) are carried and operated by their respective deliveryman. The customer terminal 4 and the vendor terminal 3 are operated by customer and vendor, respectively.

In order for the customer to receive the goods delivery service by the system 1, the customer joins system 1 and requests the customer application 4ap (S1), downloads the application (S2), and installs it in the customer terminal 4. By operating the customer application 4ap, the customer can browse the catalog of goods provided by each vendor registered in the vendor database 3db, select goods, and request delivery.

When the customer joins the system 1, the customer identification information is registered in the customer database 4db. The management server 2 processes the payment for goods and delivery based on the information registered in the customer database 4db in response to the request from the customer terminal 4. The customer also performs credit card registration at the time of the join.

The vendor signs a contract with the operator of the system 1, joins the system 1, uses the vendor terminal 3, requests the management server 2 to download the vendor application 3ap (S3), downloads the application (S4), and installs on the vendor terminal 3. The vendor application 3ap is used, for example, when exchanging information about orders for goods with the management server 2.

When the vendor joins the system 1, the vendor identification information and the catalog (goods list or menu) including the price of goods supplied by the vendor are registered to the vendor database 3db. The catalog is provided to the customer by the management server 2 so that the customer can browse and select goods.

Each of deliverymen also joins the system 1 and request to download of the application 5ap for the deliveryman terminal (S5, S7), downloads the application (S6, S8), and install it in each deliveryman terminal 5.

When the deliveryman joins system 1, the deliveryman identification information and the delivery business starting place 55 specified by the deliveryman are registered on the deliveryman database 5db of the management server 2. The delivery business starting place 55 is a place information where each of plural deliveryman always locate.

In the system 1, when at least one vendor, customer, and deliveryman join the system 1 and registration is completed, the minimum configuration of the system 1 as a goods delivery contract system is set and its function operates. Preferably, as a number of vendors joining the system 1 increases, types of goods that the customer can select will increase, which will be convenient for customer. As a number of customers joining the system 1 increases, profits of vendors and operators increase. Also, the greater number of deliverymen joining the system 1 around goods suppling place by each vendor, the smoother the system 1 will operate.

The customer who has joined to the system 1 uses the customer application 4ap to place an order for goods and a delivery request to the management server 2 (see S9, FIGS. 3 & 4).

In the management server 2, when the request receiving means 22 receives an order for goods and a request for delivery, the order notice means 23 notices the information to vendor terminal 3 where the order was placed (see S10, FIG. 5). At the same time, the order notice means 23 notices all at once delivery request to the deliveryman terminal 5 (1)(2) (see S11, S12), which registers the always locate place (for example, home or office) near the vendor (more specifically, goods supply place 35) as the starting place 55 of the delivery business. These notices are made using push notice or G-mail etc.

If the push notice or G-mail is used as a notice means, even if the vendor application 3ap or deliveryman application 5ap is not started, it can notify that there was a notice if the terminal is turned on. This simultaneous notice does not give details of order delivery. When received such a notice, the vendor or deliveryman can know the details of the order delivery by starting the application of the system 1.

When each of deliveryman (he/she) receives the above delivery notification notice at the starting place 55 of the delivery business, where he/she is always located, if he/she wishes to deliver, he/she starts the deliveryman application 5ap and looks at the notice reply screen 51a, and checks the mail contents such as a notice number (123 in the example of FIG. 5). He/she sends reply information describing an arrival time at the vendor (the goods supply place 35) and the end place 56 of the delivery business respectively to the management server 2 (S13, S14).

According to the arrival times described in the reply information, it can be seen that each deliveryman can arrive at the supply place 35 in 5 minutes and 10 minutes respectively for example. A position information of the deliveryman terminal 5 is obtained by a function of GPS device 52, then the position information will send together with reply information from the deliveryman terminal 5 to the management server 2.

The vendor confirms the acquired order request contents on the notice reply screen 31a of vendor terminal 3, inputs the time (for example, 5 minutes) required to arrange the requested goods, and replies to the management server 2 (S15, figure).

The calculation means 24 in the management server 2 calculates the delivery fee, scheduled delivery time, and total fee that the customer will bear for each deliveryman when the reply is obtained from the deliveryman terminal 5 and vendor terminal 3 (S16).

Information obtained at this calculation is the reply information of the delivery request from the deliveryman terminal 5, the position information already registered for the vendor, and the position information for the order delivery notified by the customer. The calculation means 24 uses the information to determine the delivery route on the map, calculates the moving distance and the moving time based on this moving distance and the moving speed according to the transportation 6 specified in the reply information. The calculation means 24 calculates the delivery fee based on the calculated moving time so that the amount does not fall below the minimum hourly wage of the area where the delivery business is conducted. The calculation means 24 calculates the scheduled delivery time based on the moving time of the delivery man.

The selection means 25 in the management server 2 compares the delivery fee calculated for each delivery man and selects the delivery man with the minimum delivery fee for example (S17). In this example, the deliveryman of deliveryman terminal 5 (1) that replied with 5 minutes of arrival (at step S13) is selected.

For the delivery man selected by the selection means 25, the total fee of the delivery fee and goods calculated by the calculation means 24 and the scheduled delivery time to the delivery destination specified by the customer are notified by the management server 2 to the customer terminal 4 (S18).

The customer confirms the above notice content with the customer application 4ap, and sends a consent notice of approval (S19) to the management server 2 using the same application 4ap.

Then, the management server 2 performs an inquiry (S20) to the intermediate processing company 7 which process for card settlement in order to confirm (credit) whether the customer's credit card registered at joining the system 1 can be used.

When the credit approval that the card is valid is notified by the intermediate processing company 7 of the card processing (S21), the management server 2 send a notice of delivery decision for the delivery request to the deliveryman terminal 5 of the selected deliveryman (S22).

By the delivery decision notice, the selected deliveryman can confirm the delivery time to the vendor store, the details of the delivery destination, the address specified in the business end place etc., and starts the delivery business. The deliveryman confirms the delivery decision notice, and uses the deliveryman application 5ap to return the delivery fee acceptance notice to the management server 2 (S23).

The management server 2 notifies the vendor terminal 3 of the final decision to place an order for goods (S24). This notification includes the time when the deliveryman will come to pick up the goods, thereby asking the vendor to confirm that the goods are complete by that time. Notice (S24) from the management server 2 to the vendor is done almost at the same time as notice (S22) to the deliveryman. The vendor uses the vendor application 3ap to reply the consent notice to the management server (S25).

After receiving the consent notice from both the deliveryman and the vendor, the management server 2 sends the order decision result notice to the customer terminal 4 for the final confirmation of the goods delivery (S26).

The management server 2 instructs the intermediate processing company 7 to settle the card together with the transmission of the order decision result notice (S27). The intermediate processing company 7 instructs the card company 8 to settle the card (S28), and the card company 8 completes the settlement of the goods delivery fee.

The deliveryman receives the delivery goods from the vendor 3 in time for the delivery time scheduled above, delivers them to the specified delivery place 45, and delivers the goods. After that, taps the delivery completion button on the screen with the deliveryman application 5ap and notifies the management server 2 of the completion of the delivery business up to the customer. After that, by going to the end place 56 of the delivery business, the delivery business notified by the notice number (for example, 123) is completed.

In the above, it was explained that the selection means 25 of the management server 2 selects the deliveryman, but the system 1 is not limited to fully automatic selection by such selection means 25, but it may be configured as semi-automatic selection where the staff selects the deliveryman 5. In that case, for example, the calculation means 24 or selection means 25 displays a list of delivery fees calculated for each deliveryman on the screen of the management server 2 so that the person in charge of selection can select the deliveryman by looking at it. For the list of delivery fees, the required time to the supply place of goods, the estimated time of arrival, the past delivery record, the work evaluation, etc. can be referred to for each deliveryman. This makes it possible to select a deliveryman at the discretion of the person in charge of selection, and for each member who joins the system 1, better operation is expected, which is different from machine selection.

Also, in the above, the operator who operates the system 1 and the vendor who supplies goods have been described as separate entities, but the configuration is not limited to this, and even if the operator and the vendor who supplies goods are the same. For example, a vendor who runs a chain store that handles various goods may manage the management server 2 and operate the system 1. In such a case, the vendor who supplies goods is an operator of the system, and the vendor terminal 3 may be the same as the management server 2.

In the above, it was explained that the starting place 55 of the delivery business specifies and registers the deliveryman 5 at the time of joining to the system 1, but the registration of the starting place 55 is not limited to this method and joins to the system 1. It may be flexible to specify or change even later, and the plural place may be registrable. For example, when registering multiple places, registration may be performed for each day of the week or for each time band with the specified condition of which starting place 55 is located.

The order notice means 23 of management server 2 refers to the specified conditions of starting place 55 registered in the deliveryman database 5db (conditions such as day of the week and time band), so as to select the deliveryman appropriately. Also, multiple starting places 55 may be specified regardless of the day of the week or time. In that case, the order notice means 23 may be notified to the deliveryman terminal 5 related to the appropriate starting place 55, for example, by judging from the distance from the supply place of goods. The conformity condition as a deliveryman that the deliveryman is located at the starting place 55 should be judged by the position information of the deliveryman terminal 5 included in the reply information. A condition of the deliveryman for joining to the system 1 may be such that the deliveryman terminal 5 can send its position information to the management server 2.

It was also shown that the end place 56 of the delivery business is located away from the starting place 55 of the delivery business (FIG. 2), but it is not limited to such a configuration, the end place 56 and the starting place 55 may be the same place. In addition, the selection of the delivery man by the selection means 25 or a person in charge of selection are not limited to the selection by referring only to the delivery fee. For example, depending on the customer's request, the early delivery completion time of goods or past work evaluations, achievements etc., may also be considered.

According to this system 1, the delivery fee is calculated based on the moving route from the starting place 55 of the delivery business registered in advance by the delivery man to the end place 56 of the delivery business specified when the contract of the business is desired. Therefore, it is possible to calculate the appropriate fee for the operator and delivery man. Which deliveryman can be in charge of the delivery business depends on the result of competition with other deliveryman.

The end place 56 of the delivery business is an important item when calculating the delivery fee, and is a registration item necessary for calculating the actual labor time. This registration item can be registered every time he/she wishes to contract the delivery business, so he/she can set and register as like according to the daily and occasional schedule of the deliveryman, and the degree of freedom of action for the deliveryman increase and becomes suitable.

For example, if a deliveryman works in a workplace that is free in time, that is, in a state where giga work is possible, he can register the workplace as a place where he is always located for the base of distance calculation in the delivery business. The workplace can be registered as the starting place 55 of the delivery business and can be designated as the end place 56. In addition, when a simultaneous notice of delivery requests is received when completing a business at the workplace and returning home, it is possible to specify a place at home or on the way to the home as the end place of the delivery business. This allows them to go to the specified end place after the goods delivery is completed, which is suitable for the delivery man.

In addition, according to this system 1, always-located place specified by the delivery man himself is set as the starting place 55 of the delivery business, and the place specified by himself is set as the end place 56 of the delivery business. Therefore, it is possible to prevent the objection that the minimum hourly wage is unpaid, which is suitable for the operator. In addition, since the starting position and ending position of the delivery business will be clarified, the scope of application will be clearer when applying workers' accident compensation insurance.

### Modification Example

In the system 1, if a position of the deliveryman terminal 5 detected by the position detecting means 25 is farther than the predetermined distance from the always-located place (starting place 55 of delivery business) registered in advance for that deliveryman terminal 5, the calculation means 24 may not target the deliveryman terminal 5 for calculation.

Specifically, when the deliveryman terminal 5 sends reply information to management server 2, it also sends a data of its own position information obtained by GPS device 52. The management server 2 recognizes a position of the deliveryman terminal 5 by its position information. If the position of the deliveryman terminal 5 that sent the delivery request is more than a predetermined distance from the registered always-located place, the calculation means 24 excludes the deliveryman terminal 5 from the calculation target for requesting delivery. The predetermined distance, which is the criterion for determining whether or not to perform calculation, may be set to, for example, the degree of the error in consideration of the error (about 5 to 10 m) of position measurement by GPS.

By performing such above processing, the operator will pay the deliveryman a proper minimum hourly wage. In order for the deliveryman's labor time to be properly evaluated, it is need to be judged whether or not the deliveryman will always be in the place where he/she is located, receive a simultaneous notice at that place, and receive the delivery business, without spending the time for waiting. If the deliveryman is waiting near the goods supply place 35 (for example, a vendor store) instead of the place registered to the place where he is always located, waiting time may also be a waiting work time. According to the modified system 1, such a waiting work time can be eliminated, then the operator can pay the labor compensation to the delivery man more appropriately.

### Application Example

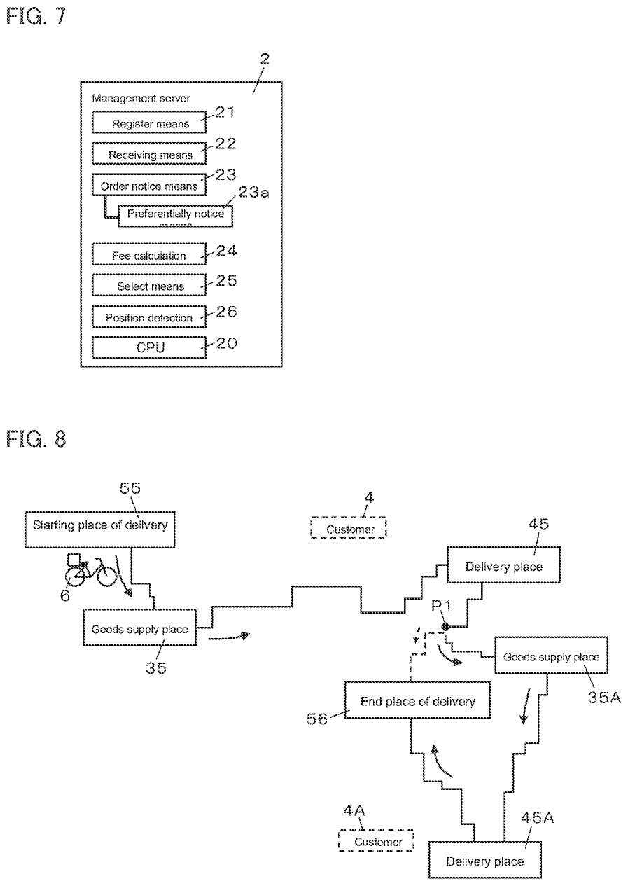

An application example of the system 1 will be explained with reference to FIGS. 7 & 8. In this application example, as shown in FIG. 7, the order notice means 23 of management server 2 has a preferentially notice means 23a, and the others are the same as those of the embodiment of the system 1. The preferentially notice means 23a preferentially sends information about the new delivery business to the deliveryman who is moving toward the end place of the delivery business after completing the delivery of goods to the customer. The notice is performed by, for example, push notice, which is a communication technology on the Internet from the management server 2 to the deliveryman terminal 5.

The moving route shown in FIG. 8 shows a new delivery of goods from a new customer while the deliveryman completes the delivery of goods to the recipient of goods at delivery place 45 of goods and is moving towards end place 56 of the delivery business. This is the route when the system 1 receives a new request. The new customer uses a customer terminal 4A to send a request to the management server 2 to deliver the goods supplied at the new supply place 35A to the specified delivery place 45A.

When a receiving means 22 of the management server 2 receives a new delivery request, the position detecting means 25 of management server 2 detects the deliveryman terminal 5 is at a position (P1) on the way to the end place 56 of the delivery business after finishing the delivery. Position (P1) is desirable within a specified distance from the supply place 35A of goods related to the new request. The specified distance may be, for example, the distance from the supply place 35A to a nearest starting place among the starting places of the delivery business registered around the supply place 35A. This specified distance can be set arbitrarily.

The preferentially notice means 23a notices push the occurrence of a new delivery request to the deliveryman who is at moving position P1. This notice gives priority to the deliveryman, and is not notified to other deliverymen. The deliveryman can use the deliveryman app 5ap to check the information of the goods supply place 35A and the goods delivery place 45A specified by the customer regarding the delivery business.

When the deliveryman contracts this new delivery business, he sends reply information requesting to the management server 2, completes the delivery of goods through the same processing sequence as described above, ends the delivery business, and head to end place 56. This embodiment of preferentially notice is intended for a new delivery request, and is not limited to the case where the supply place 35 of goods and the new supply place 35A are different, and may be the same place. Also, the end place 56 of the delivery business is not limited to the default place at that time, and a new end place may be specified when sending reply information of contract request for this preferentially notice.

The number of deliverymen who receive preferential notice from the preferentially notice means 23a is not limited to one, but may be multiple. Also, the end place of the new delivery business may be redesignated to a place different from the end place 56 at that time. In the processing of such preferentially notice, the deliveryman who receives the notice can decide at his/her own free will whether or not to contract the business, and can make a choice suitable for himself/herself.

The present invention is not limited to the above configuration and can be modified in various ways. For example, the goods targeted for delivery by the system 1 may include service business. For example, there is a delivery business service that drives a car to a place specified by a customer by substitute drive service.

### EXPLANATION OF SYMBOLS

1 goods delivery contract system
2 management server
21 registration means
22 request receiving means
23 order notice means
23a preferentially notice means
24 fee calculation means
25 selection means
26 position detecting means
3 vendor terminal
31 vendor response means
35, 35A goods supply place
4, 4A customer terminal
45, 45A delivery place
5 deliveryman terminal
51 deliveryman response means
55 starting place of delivery
56 end place of delivery
6 transportation

1. A goods delivery contract system comprising:
a management server managed by an operator who operates the goods delivery contract system;
a customer terminal used by a customer who joins the system for requesting the management server to order and deliver goods;
a vendor terminal used by a vendor who joins the system and supplies the goods;
a deliveryman terminal carried by a deliveryman who joins to the system to contract for a delivery business that receives the goods at a supply place and delivers them to the customer;
the management server comprising,
a request receiving means that receives from the customer terminal goods order delivery requests specifying a delivery place,
an order notice means that notifies the vendor terminal of information about the goods order delivery request received by the request receiving means, and notifies plural deliveryman terminals all at once of information about the goods order delivery request received by the request receiving means, wherein a place where each deliveryman is always located is registered on the management server as the starting place of delivery business, and
a calculation means for calculating a delivery fee for each deliveryman based on reply information requesting delivery sent from the deliveryman terminal;
the deliveryman terminal has a deliveryman response means for sending the reply information including a delivery business end place designated by the deliveryman to the management server in response to a notice from the order notice means;
wherein in the goods delivery contract system the calculation means of the management server is configured;
to calculate a total moving distance based on a first distance from the delivery starting place which is registered on the management server to a goods supply place by the vendor, a second distance from the goods supply place to the delivery place, and a third distance from the delivery place to the delivery business end place,
to calculate a required moving time based on the total moving distance and a running speed of a transportation used by the deliveryman, and
to calculate a delivery fee for each deliveryman based on the moving time and minimum hourly wage in an area where the delivery business takes place.

2. The goods delivery contract system in accordance with claim 1, wherein
the management server has a position detecting means that detects position of the deliveryman terminal,
the position detecting means is configured
to judge whether or not the position of the deliveryman terminal detected by the position detecting means is farther than the specified distance from a registered place where the deliveryman always locates, and
to exclude the deliveryman terminal from the calculation if it is determined that they are far apart.

3. The goods delivery contract system in accordance with claim 1, wherein
the management server has a position detecting means that detects the deliveryman terminal position,
the order notice means is configured to detect whether or not the position of the deliveryman terminal detected by the position detecting means is in a moving towards the delivery end place after delivery by the deliveryman,
if it is detected that the deliveryman terminal is in the moving towards the delivery end place, and newly delivery business occurs, the order notice means is configured
to detect whether or not a position of the deliveryman terminal is within a predetermined distance from a goods supply place of the newly delivery business, and
to preferentially push notice about the new delivery business to the deliveryman terminal when detected position is within the specified distance.

4. The goods delivery contract system in accordance with claim 1, wherein
the management server has a selection means that selects a deliveryman based on the delivery fee for each deliveryman calculated by the calculation means;
the calculation means is configured to calculate the total cost of the delivery business by the deliveryman and ordered goods;
the order notice means is configured
to notify the customer terminal of the total charge and scheduled delivery time for the deliveryman selected by the selection means, and
to notify the vendor terminal and the selected deliveryman terminal respectively of the decision to order goods and the decision to request delivery, when a consent notice from the customer terminal is received.
